(19) United States
(12) Patent Application Publication
(10) Pub. No.: US 2019/0343148 A1
(43) Pub. Date: Nov. 14, 2019

(54) GEL COMPRISING A LIQUID COPRODUCT FROM AGRO-INDUSTRY AND USE THEREOF FOR REARING INSECTS

(71) Applicant: YNSECT, Evry Cedex (FR)

(72) Inventors: Fanny Peyrichou, Souillac (FR); Solene COMPARAT, Evry (FR); Loïc CLESSE, Roisel (FR); Thibault DU JONCHAY, Chevrières (FR); Thomas LEFEBVRE, Soisy Sur Seine (FR); Myriem BOUZIANE, Paris (FR); Fabrice BERRO, Paris (FR); Benedicte LORRETTE, Montlhery (FR); Nathalie BEREZINA, Paris (FR)

(73) Assignee: YNSECT, Evry Cedex (FR)

(21) Appl. No.: 16/474,172

(22) PCT Filed: Dec. 28, 2017
(86) PCT No.: PCT/EP2017/084783

§ 371 Date: Jun. 27, 2019

(30) Foreign Application Priority Data
Dec. 29, 2016 (FR) 1663523

(51) Int. Cl. A23K 10/38; A23K 10/28; A23K 10/18; A23K 10/33; A23K 50/90; A23K 20/163; A23K 20/174

(52) U.S. Cl. CPC A23K 10/38; A23K 10/28; A23K 10/18; A23K 20/174; A23K 50/90; A23K 20/163; A23K 10/33

(57) ABSTRACT

The present invention relates to a gel used as a source of water and/or nutrients for rearing insects. The gel comprises 90 to 99.6% by weight of an aqueous substrate comprising at least 25% by weight, of the total weight of the aqueous substrate, of a liquid coproduct from agro-industry, 0.3 to 2% by weight of a gelling agent, and 0.1 to 5% by weight of a preservative, the percentages by weight of aqueous substrate, gelling agent and preservative being expressed over the total weight of the gel.

The present invention relates to the nutrition of insects and in particular supplying them with water in the form of gel. The invention further relates to a nutrition regime, a method for preparing said gel, as well as its applications in particular in the rearing of insects.

Industrial rearing of insects is undergoing rapid growth and constitutes a major challenge for animal and human nutrition, now and in the future, in particular as an alternative source of animal proteins.

However, industrialization of the rearing of insects, in particular Tenebrio molitor, is under constant development and is proving to be highly complex for the actors in this area.

The larvae of Tenebrio molitor are particularly highly valued, as they require little feed and water to develop in their natural environment.

In industrial rearing, however, breeders must make sure that the larvae are growing well, and constantly gaining weight. It has been found that supplying water plays a key role for their proper growth. Thus, it is necessary to optimize the nutrition regime and in particular the supply of water, according to the actual nutritional needs of the larvae, and to be able to adjust the right amounts of water and nutrients according to the circumstances.

Furthermore, the water requirements for the insects are generally of the order of 2 kg of water for producing 1 kg of mature insects (larvae ready to be killed). On an industrial scale, this therefore represents large volumes of water that must be supplied and that must be managed correctly. In fact, poor water management may result in either insufficient growth in the case when the quantity of water is inadequate, or a problem of increased mortality of the insects due mainly to an increase in microbiological risk and/or to risks of the insects becoming stuck if water is added to the rearing medium.

To date, the rearing medium for insect larvae is for example constituted by a nutrient medium such as wheat bran and comprising fresh fruit and vegetables as the source of water. Water may also be supplied to the insects via atmospheric water or by direct moistening of the substrate.

However, these media do not always obtain satisfactory growth and/or acceptable mortality.

In fact, these media generally have at least one of the following drawbacks: a water supply that is too restricted, inability to evaluate the precise amount of water introduced/to be introduced into the rearing medium, excessive moistening of the medium promoting the development of mould or stickiness, complex management of water requirements, difficult waste management, which is generally a source of microbiological risk, water supply at a limited rate for industrial rearing.

Thus, there is a need for a nutrition regime that is inexpensive, easy implement, and that allows both optimized growth of the larvae and controlled mortality.

Work undertaken by the inventors was able to demonstrate that supplying water in the form of a specific gel made it possible to solve the aforementioned drawbacks.

The present invention therefore relates to a gel comprising:
from 90 to 99.6% by weight of an aqueous substrate comprising at least 25% by weight with respect to the total weight of aqueous substrate, of a liquid coproduct from agro-industry,
from 0.3 to 2% by weight of a gelling agent, and
from 0.1 to 5% by weight of a preservative,
   the percentages by weight of aqueous substrate, gelling agent and preservative being expressed with respect to the total weight of the gel,

said gel having a water content greater than 50% by weight with respect to the total weight of gel.

In the present application, unless specified otherwise, all the numerical values given are understood to be inclusive.

The inventors have in fact shown that supplying water in the form of gel comprising an aqueous substrate comprising at least 25% by weight with respect to the total weight of aqueous substrate, of a liquid coproduct from agro-industry gave good assimilation of the water and nutrients by the insects, leading to excellent growth, while limiting the costs of production by utilizing coproducts from agro-industry. Furthermore, use of the gel as a source of water advantageously makes it possible to stabilize the medium from a microbiological standpoint and to safeguard the insects from possibly becoming stuck. Moreover, the use of the liquid coproducts in the form of gel as a source of water and nutrients makes it possible to supply the insects with nutrients having good nutritional qualities, as these nutrients do not undergo any industrial drying step, which could degrade them. Furthermore, the liquid coproducts from agro-industry are abundant and moreover have a low purchase price. In addition, these liquid coproducts are converted efficiently by certain insects, in particular by Tenebrio molitor.

The preferred insects for factory farming are for example the Coleoptera, Diptera, Lepidoptera, Orthoptera, Hymenoptera, Dictyoptera in particular grouping together the Blattoptera, including the Isoptera, and the Mantoptera, Phasmoptera, Hemiptera, Heteroptera, Ephemeroptera and Mecoptera, preferably the Coleoptera, Diptera, Orthoptera, Lepidoptera, Blattoptera; or mixtures thereof.

Preferentially, the insects are selected from the group constituted by Tenebrio molitor, Hermetia illucens, Galleria mellonella, Aiphitobius diaperinus, Zophobas morio, Blattera fusca, Tribolium castaneum, Rhynchophorus ferrugineus, Musca domestica, Chrysomya megacephala, Locusta migratoria, Schistocerca gregaria, Acheta domestica, Samia ricini or mixtures thereof, and even more preferentially, Tenebrio molitor.

More preferentially, the invention relates to the insect species that have grinding mouthparts such as species belonging to the order Coleoptera, Lepidoptera in particular at the larval stage or Hymenoptera; or have piercing mouthparts, such as species belonging to the order Diptera or Hemiptera.

This gel is suitable advantageously for the species belonging to the order Coleoptera such as scarab beetles, ladybirds, stag beetles, leaf beetles, chafers, weevils, ground beetles, and more particularly for the species of the family Tenebrionidae. The gel regime is typically used for rearing Tenebrio molitor (mealworm).

Advantageously, the gel is adapted to the larval stage of the insect species mentioned above.

A coproduct is a material inevitably created during a process of manufacturing a product of interest.

In particular, the coproduct to which the invention relates is liquid. By “liquid” is meant that the coproduct is in liquid form at ambient temperature under normal conditions of atmospheric pressure. In particular, this means that it is a coproduct obtained directly at the end of an industrial process without carrying out any drying step.

More particularly, the liquid coproduct is an aqueous coproduct comprising soluble substances. Preferentially, the soluble substances present in the liquid coproduct are proteins and/or carbohydrates such as sucrose and/or lactose, more preferentially proteins and carbohydrates. The soluble substances may also comprise soluble fibres.

Advantageously, the liquid coproduct comprises at least 90% by weight of soluble substances with respect to the total weight of dry matter. In other words, the coproduct comprises less than 10% of insoluble substances with respect to the total weight of dry matter.

By “agro-industry” is meant more particularly the industries for starch manufacture, potato starch manufacture, malting, bioethanol production, sugar production, fermentation, brewing, distilling and the dairy industry.

The liquid coproducts of these industries result from the effluents and more particularly from the waters generated in the course of the various manufacturing processes that are the purpose of these industries.

Starch manufacture and potato starch manufacture aim to separate the constituents of the plant and in particular starch or potato starch, respectively. Malting aims to cause barley to germinate and to prepare malt, by a process called malting.

In starch manufacture and potato starch manufacture, the waters generated in the course of the manufacturing processes, for example during steeping of the raw material in water, are called “solubles”.

There are various types of solubles, depending on the raw material used in this manufacturing process: wheat, maize, potato, pea, barley, cassava solubles.

There may be mentioned as examples of solubles, CORAMI® (originating from wheat), SOLULYS® (originating from maize) marketed by ROQUETTE or AMYSTEEP 424® (originating from maize) marketed by TEREOS.

Preferably, the solubles are selected from the wheat solubles and/or the maize solubles.

There are also distillers' solubles. The latter are obtained by fermentation-distillation of the solubles during the bioethanol production process. They are therefore distillers' solubles from wheat, maize, pea, cassava, barley, and from cereals (for example wheat, maize, barley).

Another liquid coproduct may result from this bioethanol production process: yeast cream.

As described in detail hereinafter, a yeast cream may be obtained by other methods such as for example fermentation, distilling or brewing or in bioprocesses for producing propanediol, succinic acid or polyhydroxyalkanoates.

In the case of a cream from yeasts resulting from a bioethanol production process, advantageously this is from active or inactive yeasts recovered by filtration at the end of the fermentation process.

As examples of yeast creams, it is possible to find in particular yeast creams from the alcoholic fermentation of wheat solubles.

Distillation solubles often comprise the yeasts utilized in fermentation and (undistilled) solubles.

As examples of distillation solubles, there may be mentioned ALCOMIX® (originating from wheat) marketed by TEREOS, CORAMI® BE (originating from wheat) marketed by ROQUETTE, PROTIWANZE® (originating from wheat). There is also a distillation soluble originating from wheat, maize and barley.

The sugar industry aims to extract sugar from sugar beet or sugar cane. The sugar industry generates several kinds of liquid coproducts and in particular mother liquors and molasses.

Mother liquors and molasses correspond to the syrupy residues obtained after crystallization of the liquor formed during sugar manufacture. The sugar content is higher in mother liquors than in molasses.

There are different types of molasses and mother liquors depending on the raw material utilized in this sugar manufacturing process: sugar cane molasses, sugar beet molasses, sugar cane mother liquors, and sugar beet mother liquors.

As examples of molasses, there may be mentioned sugar cane molasses such as that marketed by PRIMEAL and sugar beet molasses.

The fermentation, distillation and brewing industries utilize microorganisms for producing microorganisms by multiplication (for example yeasts, in particular baker's yeasts), for producing biological substances such as amino acids (glutamic acid, lysine), organic substances (enzymes) or alcohol.

Alcohol may be produced starting from raw material of various origins such as by fermentation of fruit (grape, beet, sugar cane), of cereals (wheat, maize), or of cassava.

These industries generate several kinds of liquid coproducts including vinasses and yeast creams.

Vinasses are liquid coproducts originating from the fermentation of mash following extraction of the compounds of interest.

As examples of vinasses, there may be mentioned the products VI NASSE 60® (vinasse for producing baker's yeasts) and VIPROTAL® (beet syrup vinasse originating from fermentation for producing baker's yeasts) marketed by LESAFFRE, PRL 364® (beet syrup and glucose vinasse originating from fermentation for producing glutamic acid) and SIRIONAL® (beet syrup and glucose vinasse originating from fermentation for producing lysine) marketed by AJINOMOTO.

Yeast creams correspond to the coproducts resulting from the separation of mash such as by filtration or centrifugation after fermentation.

By “fermentation” is meant any process using microorganisms such as for example yeasts, bacteria and/or fungi, for converting raw materials.

As noted above, yeast creams may comprise microorganisms in an active or inactive form, advantageously yeasts.

The dairy industry produces in particular cheese, butter, and cream.

Whey, also called lactoserum, is a liquid coproduct generated in particular during cheesemaking. Whey, which exists in two forms, sweet whey and acid whey, is rich in milk proteins and nutrients. Whey protein concentrates (WPCs) in liquid form are ingredients derived from whey by removing part of the water, the minerals and the lactose. Permeate is a coproduct resulting from the manufacture of milk or whey protein concentrates, by ultrafiltration. It contains soluble particles from milk or whey, salts and lactose. The liquid permeate may be concentrated and used before drying.

The liquid coproduct is therefore advantageously selected from the list comprising solubles from cereals, solubles from maize, solubles from wheat, solubles from peas, solubles from cassava, solubles from sugar beet, solubles from sugar cane, distillers' solubles from cereals, distillers' solubles from wheat, distillers' solubles from maize, distillers' solubles from peas, distillers' solubles from cassava, vinasses, molasses, yeast creams, whey and concentrated derivatives thereof, in particular permeate, or mixtures thereof.

Use of these liquid coproducts in insect nutrition makes it possible to reduce the costs associated with nutrition, while promoting good growth of the insects by supplying a coproduct that has good nutritional properties. In fact, the coproducts in liquid form allow better growth than the dry coproducts. This can be explained by the fact that the methods of industrial drying used in the manufacture of the dry coproducts affect the nutritional quality of the coproducts thus obtained. Thus, the liquid coproducts have better nutritional quality than the dry coproducts.

Advantageously, the liquid coproduct comprises a water content greater than 35% with respect to the total weight of the coproduct. Preferentially, the water content is greater than or equal to 40%, more preferentially greater than or equal to 50%.

Preferentially, the liquid coproduct is selected from the list comprising solubles from cereals, solubles from maize, solubles from wheat, distillers' solubles from cereals, distillers' solubles from wheat, distillers' solubles from maize, vinasses, yeast creams, whey and concentrated derivatives thereof, in particular permeate, or mixtures thereof.

Advantageously, the aqueous substrate comprises water and the coproduct from agro-industry. Preferably, the aqueous substrate is constituted by water and the coproduct from agro-industry.

Preferably, the aqueous substrate has a total water content comprised between 56 and 98.2% by weight with respect to the total weight of aqueous substrate, preferably comprised between 60 and 95% by weight, more preferentially between 70 and 90% by weight.

The gel comprises from 0.3 to 2% by weight of a gelling agent, preferentially from 0.5 to 1.5% by weight of a gelling agent, the percentages by weight being given with respect to the total weight of gel.

Preferably, the water content of the gel is greater than 50% by weight with respect to the total weight of gel, preferably from 65 to 85% by weight with respect to the total weight of gel.

The presence of a preservative in the gel makes it possible to limit the development of moulds in the gel. Preferably, the content of preservative is comprised between 0.1 and 3% by weight, more preferentially between 0.15 and 0.5% by weight, such as for example 0.3% by weight with respect to the total weight of gel.

Advantageously, the preservative is selected from the preservatives usable in animal nutrition and more particularly from the group constituted by acetic acid, sodium acetate, formic acid, fumaric acid, citric acid, sorbic acid, potassium sorbate, calcium sorbate, propionic acid, sodium propionate, calcium propionate, benzoic acid, sodium benzoate, calcium benzoate, potassium benzoate, butyric acid, as well as the salts and acids corresponding to these molecules.

Preferably, the preservative is not a paraben.

According to a particular embodiment of the invention, the gel comprises:
from 90 to 99.6% by weight of an aqueous substrate comprising at least 25% by weight with respect to the total weight of aqueous substrate, of a liquid coproduct from agro-industry,
from 0.3 to 2% by weight of a gelling agent, and
from 0.1 to 5% by weight of a preservative, the preservative being selected from the preservatives usable in animal nutrition and more particularly from the group constituted by acetic acid, sodium acetate, formic acid, fumaric acid, citric acid, sorbic acid, potassium sorbate, calcium sorbate, propionic acid, sodium propionate, calcium propionate, benzoic acid, sodium benzoate, calcium benzoate, potassium benzoate, butyric acid, as well as the salts and acids corresponding to these molecules, the percentages by weight of aqueous substrate, gelling agent and preservative being expressed with respect to the total weight of the gel,
   said gel having a water content greater than 50% by weight with respect to the total weight of gel.

Preferably, the preservative is potassium sorbate or sodium propionate.

The coproduct from agro-industry is liquid at ambient temperature.

Preferentially, the content of aqueous substrate is between 95 and 99% by weight with respect to the total weight of gel.

Advantageously, the aqueous substrate comprises at least 50% by weight of a liquid coproduct from agro-industry with respect to the total weight of aqueous substrate.

Advantageously, the aqueous substrate comprises water and at least 50% by weight, for example at least 75% by weight, of coproduct from agro-industry. Preferentially, the aqueous substrate is constituted by water and at least 50% by weight, for example at least 75% by weight, of coproduct from agro-industry.

According to a particular embodiment of the invention, when molasses is used, it is advisable to use a maximum amount of 55% by weight of molasses in the substrate.

According to another particular embodiment of the invention, when vinasse is used, it is advisable to use a maximum amount of 70% by weight of vinasse in the substrate.

According to a third particular embodiment of the invention, when yeast cream is introduced into the aqueous substrate, it is advisable for it to be introduced via a mixture of coproducts, so that the quantity of yeast cream does not exceed 25% by weight in the aqueous substrate.

According to a particular embodiment of the invention, the aqueous substrate comprises water and at least 95% by weight of coproduct from agro-industry. Preferentially, the aqueous substrate comprises water and at least 95% by weight of coproduct from agro-industry.

According to a particular embodiment of the invention, the aqueous substrate consists of a liquid coproduct from agro-industry.

Preferentially, the liquid coproduct is selected from the list comprising:

solubles from cereals, solubles from maize, solubles from wheat, solubles from cassava, distillers' solubles from cereals, distillers' solubles from wheat, distillers' solubles from maize, distillers' solubles from cassava, yeast cream, whey and concentrated derivatives thereof, in particular permeate, or

a mixture of at least two coproducts selected from solubles from cereals, solubles from maize, solubles from wheat, solubles from cassava, distillers' solubles from cereals, distillers' solubles from wheat, distillers' solubles from maize, distillers' solubles from cassava, yeast cream, whey and concentrated derivatives thereof, in particular permeate, yeast creams, vinasses and molasses.

Preferably, the aqueous substrate has a total water content comprised between 50 and 95% by weight with respect to the total weight of aqueous substrate.

Preferentially, the liquid coproduct from agro-industry is a distillers' soluble or a mixture of a distillers' soluble with another liquid coproduct.

Advantageously, the distillers' soluble is selected from the group constituted by distillers' solubles from wheat, distillers' solubles from maize and distillers' solubles from cereals.

As noted above, the gel according to the invention also contains a gelling agent.

Advantageously, the gelling agent is selected from the group constituted by agar-agar, carrageenan, guar gum, calcium alginate, chitosan, pectin, xanthan gum, carob gum, gellan gum or mixtures thereof.

According to another particular embodiment of the invention, the gel comprises:
from 90 to 99.6% by weight of an aqueous substrate comprising at least 25% by weight with respect to the total weight of aqueous substrate, of a liquid coproduct from agro-industry,
from 0.3 to 2% by weight of a gelling agent, the gelling agent being selected from the group constituted by agar-agar, carrageenan, guar gum, calcium alginate, chitosan, pectin, xanthan gum, carob gum, gellan gum or mixtures thereof, and
from 0.1 to 5% by weight of a preservative,
   the percentages by weight of aqueous substrate, gelling agent and preservative being expressed with respect to the total weight of the gel,
   said gel having a water content greater than 50% by weight with respect to the total weight of gel.

More particularly, the gel comprises:
from 90 to 99.6% by weight of an aqueous substrate comprising at least 25% by weight with respect to the total weight of aqueous substrate, of a liquid coproduct from agro-industry,
from 0.3 to 2% by weight of a gelling agent, the gelling agent being selected from the group constituted by agar-agar, carrageenan, guar gum, calcium alginate, chitosan, pectin, xanthan gum, carob gum, gellan gum or mixtures thereof, and
from 0.1 to 5% by weight of a preservative, the preservative being selected from the preservatives usable in animal nutrition and more particularly from the group constituted by acetic acid, sodium acetate, formic acid, fumaric acid, citric acid, sorbic acid, potassium sorbate, calcium sorbate, propionic acid, sodium propionate, calcium propionate, benzoic acid, sodium benzoate, calcium benzoate, potassium benzoate, butyric acid, as well as the salts and acids corresponding to these molecules,
   the percentages by weight of aqueous substrate, of gelling agent and of preservative being expressed with respect to the total weight of the gel,
   said gel having a water content greater than 50% by weight with respect to the total weight of gel.

According to a particularly advantageous aspect of the invention, the gelling agent is a mixture of xanthan and carob gums, a mixture of xanthan and guar gums, or of agar-agar.

Advantageously, the gelling agent comprises a 50/50 mixture of xanthan gum and carob gum. As an example, a gelling agent of this kind is marketed under the name Flanogen® XL12 by Cargill. Carob gum has the advantage that it has an attractive effect on insect larvae and in particular on the larvae of Tenebrio molitor.

According to a particular embodiment of the invention, the gel comprises yeasts.

The yeasts may be active or inactive.

By “inactive yeasts” is also meant yeast extracts and/or yeast flakes. By “yeast flakes” is meant the insoluble fraction of yeast, i.e. the yeast cell wall and the yeast plasma membrane. Therefore, it is neither whole yeast, nor the cellular contents of yeast, such as a yeast extract. Yeast flakes have very beneficial properties in animal or human health or as a food supplement for animals and humans.

Advantageously, the total yeast content of the gel is comprised between 0.5 and 20% of yeast dry weight, preferably from 3 to 15% of yeast dry weight, preferably from 4 to 10% of yeast dry weight with respect to the total weight of gel.

The yeasts may originate from the liquid coproduct from agro-industry.

The coproduct from agro-industry may in fact be a distillers' soluble that already comprises yeasts or a mixture of at least two liquid coproducts from agro-industry, one of which is a yeast cream.

Alternatively, the yeasts may be added in solid form, for example in the form of dry yeasts or, as indicated below, as a probiotic. In the form of dry yeasts, they are introduced at a content comprised between 0.1 and 6% by weight, preferentially between 1 and 5% by weight with respect to the total weight of the gel.

Besides the proteins, carbohydrates, soluble fibres and the optional yeasts, the coproduct from agro-industry may comprise other nutrients of interest such as minerals.

Advantageously, the sodium content of the coproduct is greater than or equal to 1% with respect to the total weight of the coproduct.

Advantageously, the liquid coproduct has a sodium content greater than 2% by weight with respect to the total weight of the coproduct.

However, too high a sodium content could prove toxic for the larvae of Tenebrio molitor and hamper their proper development. Preferably, the coproduct comprises a sodium content from 1% to 5%.

The coproduct advantageously comprises a sulphate content less than 4% with respect to the total weight of the coproduct. Too high a sulphate content could prove toxic for the larvae of Tenebrio molitor and hamper their proper development. Preferably, the coproduct comprises a sulphate content less than 3%, preferentially less than 2%, more preferentially less than 1%.

Advantageously, the gel according to the invention may further comprise calcium.

According to another embodiment, the yeasts may come from the addition of probiotics to the gel.

When a probiotic is added to the gel, this probiotic is introduced for example at a content comprised between 0.1 and 8% by weight, preferentially between 1 and 5% by weight with respect to the total weight of the gel.

As examples of probiotics, there may be mentioned the yeasts LB 2245® from the company LALLEMAND. These yeasts also comprise vitamins and minerals.

The gel according to the invention may additionally contain from 0.001 to 0.5% by weight of vitamins with respect to the total weight of the gel, such as for example from 0.001 to 0.1% by weight of vitamins with respect to the total weight of the gel.

The vitamins may be introduced in the form of a vitamin-enriched composition, such as a “premix”.

Advantageously, the premix comprises vitamins selected from the group constituted by vitamin A, vitamin B1 (thiamine), vitamin B2 (riboflavin), vitamin B3 (nicotinamide), vitamin B5 (pantothenic acid), vitamin B6 (pyridoxine), vitamin B8 (biotin), vitamin B9 (folic acid), vitamin B12 (cobalamin), vitamin C, vitamin PP (niacin), vitamin D3 (cholecalciferol), vitamin E, vitamin K2 (menaquinone), vitamin K3 (menadione) or their precursors and derivatives.

There are numerous commercial premixes, such as for example the premix AIN Vitamin Mixture 76, marketed by MP Biomedicals, LLC.

The premix may also comprise choline, cholesterol, carnitine and/or inositol, as well as minerals and/or trace elements.

Besides the aforementioned sodium and calcium, the gel may therefore advantageously comprise minerals selected from the group constituted by iron, copper, selenium, chromium, iodine, cobalt, manganese, fluorine, zinc, potassium, phosphorus, magnesium.

These minerals may also come from a coproduct from agro-industry or be added via a premix, and said premix may be a vitamin premix comprising minerals as stated above or a premix of minerals only. As examples of premixes of minerals, there may be mentioned the premix “Wesson Salt Mixture”, marketed by MP Biomedicals, LLC.

Advantageously, the vitamin premix is added to the gel at a content comprised between 0.1 and 5% by weight with respect to the total weight of gel.

The gel according to the invention advantageously has a gel strength of at least 30 g/cm², in particular 30 g/cm², 40 g/cm² or 50 g/cm², preferably 80 g/cm².

In fact, insects only accept a certain texture. They must be able to easily cut and ingest pieces of gel using their mouthparts. The gel must therefore be solid.

Advantageously, the gel strength is between 40 g/cm² and 150 g/cm², in particular between 80 g/cm² and 150 g/cm². Preferably, the gel strength is between 40 g/cm² and 100 g/cm², in particular at least 50 g/cm², or even at least 90 g/cm², more preferentially at least 100 g/cm². The gel strength is measured using a texturometer.

Thus, the gel is not sticky or adhesive. The insects can therefore move about on top of the gel without getting stuck. This therefore reduces insect mortality, fewer insects becoming trapped in the gel.

Furthermore, the syneresis of the gel may advantageously be between 0.1 and 5% to avoid excessive release of water and to moisten the insects' environment.

The syneresis of the gel may be determined, for example as indicated in G. BLANCHER (2009), Sciences du Vivant [Life Sciences], ENSIA (AgroParisTech). Measurement is carried out on products stored at 4° C. for 24 h, by differential weighing with an analytical balance. Briefly, the product contained in a cup is weighed, then the surface liquid content is removed by tilting the cup, then with absorbent paper placed lightly on the surface of the product. A second weighing is then carried out. The syneresis is expressed as the percentage loss between the two weighings.

Advantageously, the gel has a suitable form in order to facilitate the insects' access to the water. It is, for example, in the form of units (blocks) of gel having a volume comprised between 30 cm³ and 1500 cm³, such as a cube or a parallelepiped with a square base, or a cylinder with a length of the order of 0.5 to 15 cm, preferentially 0.8 to 12 cm.

The invention also relates to a nutrition regime for insects comprising a gel and a feed:
the gel being as described above, and
the feed being an insoluble substrate having a moisture content less than or equal to 55% by weight with respect to the total weight of the insoluble substrate.

The nutrition regime according to the invention thus comprises two separate products, the feed not being included in the gel.

Advantageously, the nutrition regime is used for rearing the larvae of Tenebrio molitor.

The substrate is said to be “insoluble” because it comprises at least 60% by weight of insoluble substances with respect to the total weight of dry matter. Such insoluble substances are for example selected from the group constituted by wheat bran, rice bran, maize bran, maize germ cake, maize fibres, fibres of fodder legumes, wheat middlings, distillers grains, barley rootlets (from malting), peelings from tubers, potatoes, pea pulp, beet pulp.

The contents of nutrients and water in the gel and the insoluble substrate are determined so that the larvae of Tenebrio molitor are supplied with a sufficient quantity of nutrients and water.

Advantageously, the insoluble substrate has a moisture content less than 45% with respect to the total weight of the insoluble substrate, preferentially less than 25%.

The advantage of using a gel for water supply makes it possible to reduce the microbiological risks, in particular of moulds. In fact, supplying water in the form of a gel makes it possible to limit the water content of the insoluble substrate.

The invention also relates to a method for preparing a gel according to the invention, comprising:
a step of forming a liquid compound by mixing:
   i. from 90 to 99.6% by weight of an aqueous substrate comprising at least 25% by weight with respect to the total weight of aqueous substrate, of a liquid coproduct from agro-industry, the aqueous substrate being brought to a temperature allowing dissolution of a gelling agent;
   ii. from 0.3 to 2% by weight of a gelling agent, and
   iii. from 0.1 to 5% by weight of a preservative, the percentages by weight of aqueous substrate, gelling agent and preservative being expressed with respect to the total weight of the liquid compound,
a step of cooling the liquid compound so as to bring it below a second temperature, at which it gels.

The aqueous substrate, the liquid coproduct from agro-industry, the preservative and the gelling agent are as defined above for the gel according to the invention.

The method for producing a gel according to the invention may in particular comprise the following steps:
a step of forming a liquid compound by mixing:
   i. from 90 to 99.6% by weight of an aqueous substrate comprising at least 25% by weight with respect to the total weight of aqueous substrate, of a liquid coproduct from agro-industry, the aqueous substrate being brought to a temperature allowing dissolution of a gelling agent;
   ii. from 0.3 to 2% by weight of a gelling agent, and
   iii. from 0.1 to 5% by weight of a preservative, the percentages by weight of aqueous substrate, gelling agent and preservative being expressed with respect to the total weight of the liquid compound,
      a step of drawing-off the liquid compound;
      a step of in-line cooling of the liquid compound so as to bring it below a second temperature, at which it gels;
      a step of transfer to a distribution line;
      a step of cutting up the gelled compound into blocks, as it leaves the distribution line.

By “brought to a temperature allowing dissolution of a gelling agent” is meant in particular a step of heating the aqueous substrate comprising the coproduct. This step may be carried out by any means available for this purpose. Advantageously, the aqueous substrate is heated to a temperature between 60° C. and 100° C., in particular between 60° C. and 85° C., for example of the order of 80° C.; preferably the temperature is such that it is sufficient for dissolving the gelling agent without affecting the nutritional quality of the liquid coproduct.

In particular, by “liquid compound” is understood a compound that is in liquid form at the heating temperature. In fact, this liquid compound is intended to gel on cooling down.

By “drawing off” is meant a step of extracting the liquid compound formed by the first step of mixing the aqueous substrate with the gelling agent and the preservative, from the vat in which it is located. Advantageously, the drawing-off step makes it possible to draw off a suitable quantity of liquid compound, uniformly mixed, in order to supply the insects with the quantity of gel appropriate to their requirements for water and nutrients.

By “in-line cooling” is meant a step of cooling along a device for producing gel, by a means provided for this purpose. The liquid compound drawn off is cooled while it is conveyed between the vat in which the liquid compound is located and the rearing environment of the insects. This in-line cooling brings the liquid compound to a temperature below its gelation temperature, which may be for example of the order of 40° C. More generally, the compound thus gelled is brought to a temperature compatible with the use for which it is intended. For example, for feeding and supplying water to insects, the compound, which will be distributed at a temperature close to its temperature after in-line cooling, is brought to a maximum temperature of 25° C. at the outlet from in-line cooling. The in-line cooling may be carried out once, or through several stages of cooling, by gradual and successive cooling stages.

The transfer step corresponds to conveying the gel from the cooling zone to the cutting zone. This conveying is carried out by means provided for this purpose. Advantageously, conveying is implemented at a temperature below or equal to 25° C. in order to maintain good cohesion of the gel.

The cutting-up step corresponds to a step of cutting the gel. Advantageously, cutting-up is carried out by mechanical cutting means allowing the gel to be cut according to the insects' requirements for water and nutrients.

With in-line gelling of the compound, after drawing-off in liquid form, and cutting it up into blocks directly as it leaves a distribution line, the gel is produced as and when needed and continuously. Handling the gel and storing it (in the form of gel) are eliminated, which in fact eliminates the associated problems. The risks of contamination or of development of bacteria are limited considerably, as the gel is distributed immediately on leaving the distribution line, a short time after the compound has been formed. Moreover, in the context of an insect rearing farm, the size of the blocks at the outlet may be adapted finely, and continuously, to the requirements.

The invention further relates to the use of a gel according to the invention as a source of water and/or nutrients for rearing insects.

In particular, the gel according to the invention is used as a source of water and/or nutrients, advantageously as a source of water and nutrients, for industrial rearing of insects.

Supplying a source of water is indispensable for the proper development of the insects. For the same quantity of water supplied (30% of the weight of larvae), the mealworm larvae grow 48% more quickly with a gelled source of water compared to water mixed directly with the substrate. Their individual weight gain with respect to dry matter is also 64% greater.

Moreover, the use of gel improves the growth of the larvae with respect to the use of carrots, even when they are reared at high densities such as those used in an installation for industrial production. In fact, the growth rate of the larvae under these conditions is significantly greater for the larvae reared with gel.

Giving water to the insects, in sufficient quantity, is therefore a key factor for rapid and efficient growth of the larvae. This also allows a considerable increase in productivity in an insect rearing farm and in particular of Tenebrio molitor.

This also allows better control in determining the quantity of water provided.

The gel according to the invention also makes it possible to supply beneficial nutrients.

Advantageously, this gel is used for rearing Tenebrio molitor, in particular for rearing larvae of Tenebrio molitor.

Finally, the invention relates to the use of a liquid coproduct from agro-industry in the form of gel as a source of water and/or nutrients, advantageously as a source of water and nutrients, for rearing insects, in particular for industrial rearing of insects.

The use of a liquid coproduct from agro-industry advantageously provides better control in determining the quantity of water provided, as mentioned above, as well as supply of beneficial nutrients, promoting growth of the insects, while reducing the risk of mortality.

The invention will be better understood on reading the following examples given by way of illustration, with reference to the figures:

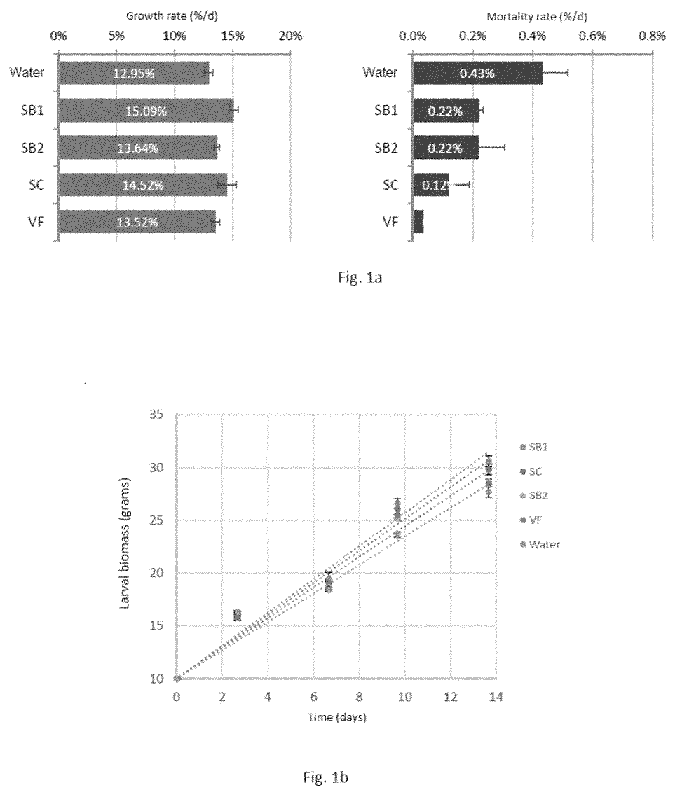

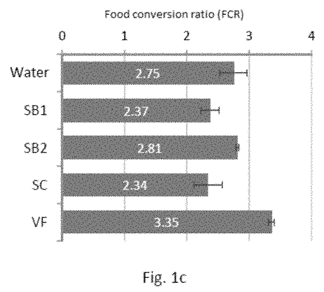

FIG. 1a is a diagram illustrating the growth and mortality of larvae of Tenebrio molitor with rearing on gels comprising various liquid coproducts from agro-industry (two solubles from wheat, a distillers' soluble from cereals and a vinasse);

FIG. 1b corresponds to the growth curve of Tenebrio molitor with rearing on gels comprising the liquid coproducts from agro-industry mentioned in FIG. 1a;

FIG. 1c is a diagram illustrating the feed conversion ratio FCR, also called consumption index, calculated for Tenebrio molitor depending on the liquid coproduct from agro-industry, in the form of gel, that was incorporated into its nutrition regime;

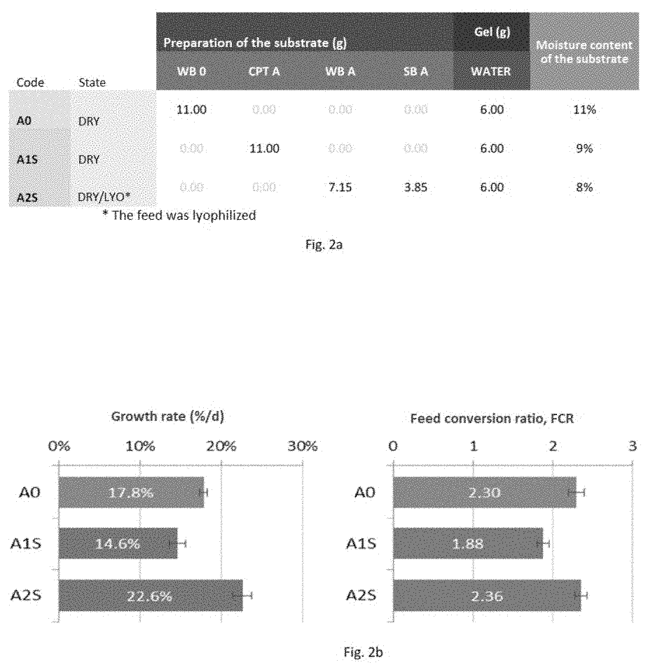

FIG. 2 comprises a FIG. 2a, which is a table showing comparative nutrition regimes comprising liquid coproducts from wheat and maize from a starch mill, dried or lyophilized, as well as a FIG. 2b, which comprises two diagrams illustrating the results obtained in terms of growth and FCR of the feed, obtained for different comparative nutrition regimes stated in FIG. 2a;

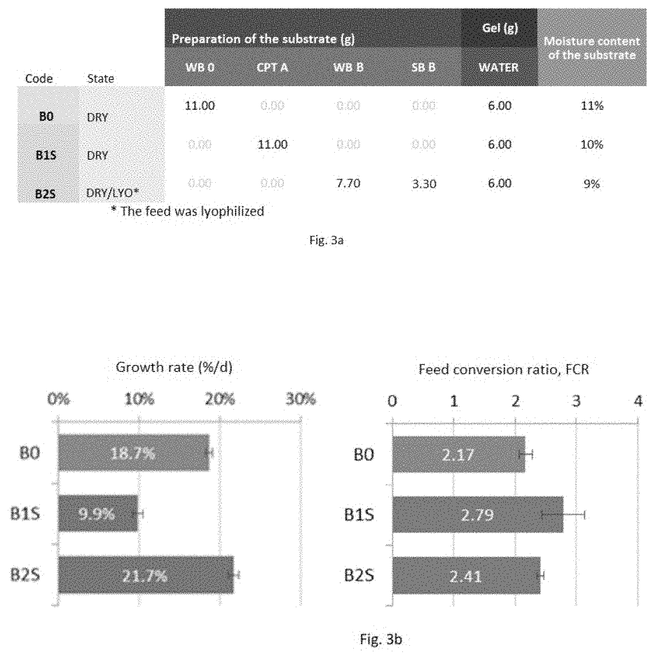

FIG. 3 comprises a FIG. 3a, which is a table showing comparative nutrition regimes comprising liquid coproducts from starch manufacture from wheat, dried or lyophilized, as well as a FIG. 3b, which comprises two diagrams illustrating the results obtained in terms of growth and FCR of the feed, obtained for different comparative nutrition regimes stated in FIG. 3a;

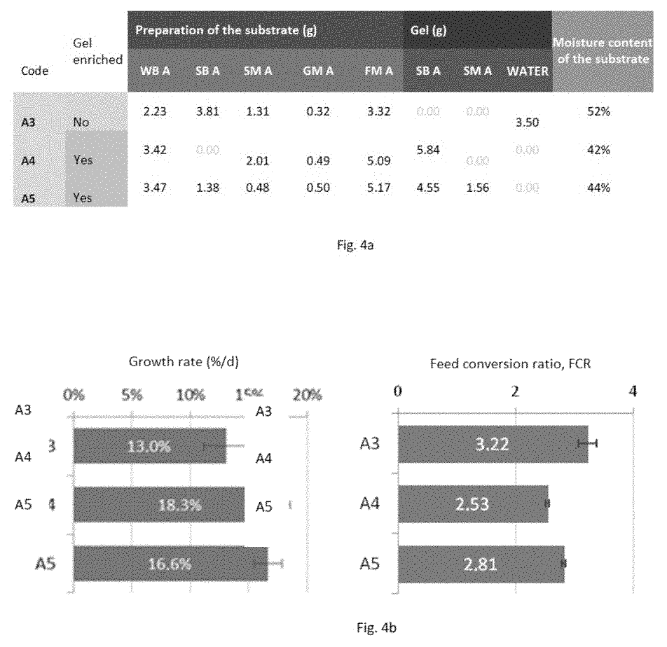

FIG. 4 comprises a FIG. 4a, which is a table showing comparative nutrition regimes comprising liquid coproducts from wheat and maize from a starch mill, in wet form or in the form of gel, as well as a FIG. 4b, which comprises two diagrams illustrating the results obtained in terms of growth and FCR of the feed, obtained for different comparative nutrition regimes stated in FIG. 4a;

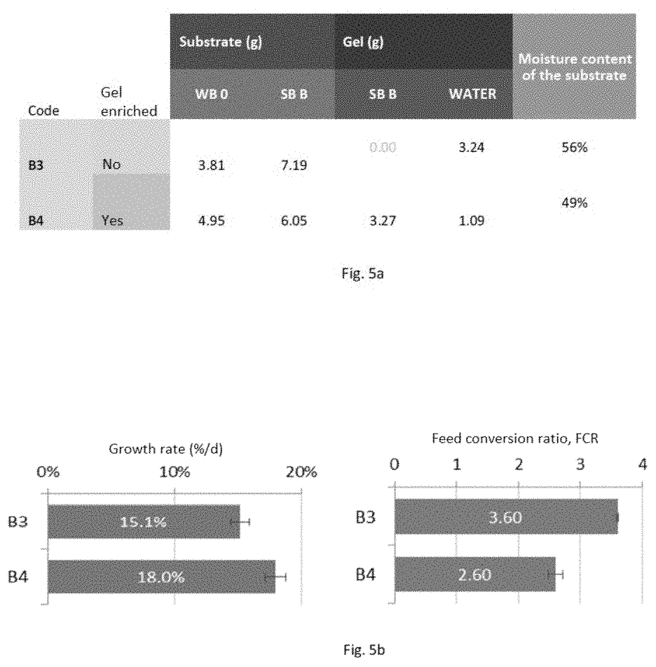

FIG. 5 comprises a FIG. 5a, which is a table showing comparative nutrition regimes comprising liquid coproducts from wheat and maize from a starch mill, in wet form or in the form of gel, and a FIG. 5b, which comprises two diagrams illustrating the results obtained in terms of growth and FCR of the feed, obtained for different comparative nutrition regimes stated in FIG. 5a; and

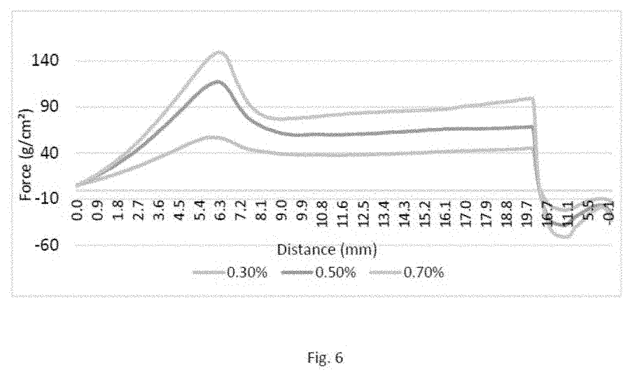

FIG. 6 shows the evaluation of the mechanical properties of the gels enriched with solubles from wheat with incorporation of gelling agent (Xanthan Carob mixture) of 0.30%, 0.50% and 0.70% of example IV (measurement of the gel strength as a function of the distance traveled by a cylindrical probe used for applying pressure to the surface of the gel) carried out using a TA-XT Plus texturometer (Stable Micro Systems, TA.XT Plus, Surrey, France) and its “Exponent” analysis software.

### EXAMPLE I: EXAMPLES OF GELS ACCORDING TO THE INVENTION

A. The Products Used in the Gels According to the Invention

a) Solubles

Solubles from Maize
SOLULYS 048E®, marketed by ROQUETTE. SOLULYS corresponds to a concentrated solution of solubles from maize obtained in the first step of fractionation of the grain, in a wet process for starch manufacture. This concentrated solution comprises 48% by weight of dry matter with respect to the total weight of solution and 44% by weight proteins and 24% by weight lactic acid, these last two percentages by weight being expressed with respect to the total weight of dry matter of the solution.
AMYSTEEP424®, marketed by TEREOS. This composition of solubles from maize comprises 42.5% by weight dry matter with respect to the total weight of the composition and 44% by weight proteins with respect to the total weight of dry matter of the composition.

Solubles from Wheat
CORAMI®, marketed by ROQUETTE. It corresponds to a soluble from starch extraction obtained following the steps of steeping and refining, in a starch mill process. This composition of wheat soluble comprises 29% by weight dry matter with respect to the total weight of the composition.

b) Distillers' Solubles

Distillers' Solubles from Wheat
ALCOMIX®, marketed by the company TEREOS. This composition of wheat soluble comprises about 20% by weight dry matter with respect to the total weight of the composition and about 28% by weight proteins with respect to the total weight of dry matter of the composition.
PROTIWANZE®, marketed by the company CROPENERGIES. This distillers' soluble from wheat comprises 27% by weight dry matter with respect to the total weight of distillers' soluble and 27% by weight proteins with respect to the total weight of dry matter of distillers' soluble.
CORAMI BE®, marketed by ROQUETTE. This distillers' soluble from wheat comprises 32% by weight dry matter with respect to the total weight of distillers' soluble and 32% by weight proteins with respect to the total weight of dry matter of distillers' soluble.

Distillers' Solubles from Cereals
distillers' soluble originating from wheat, maize and barley, supplied by the company CROPENERGIES.

c) Yeast Creams
yeast cream from wheat supplied by TEREOS.

d) Vinasses
VINASSE 60® marketed by LESAFFRE. This vinasse comprises 60% by weight of dry matter with respect to the total weight of vinasse and 60% by weight of proteins with respect to the total weight dry matter of vinasse.
VIPROTAL® marketed by LESAFFRE. This vinasse comprises 60% by weight dry matter with respect to the total weight of vinasse and 44% by weight proteins with respect to the total weight dry matter of vinasse.
PRL 364® marketed by AJINOMOTO. This vinasse comprises 70% by weight dry matter with respect to the total weight of vinasse and 70% by weight proteins with respect to the total weight dry matter of vinasse.
SIRONAL® marketed by AJINOMOTO. This vinasse comprises 66% by weight dry matter with respect to the total weight of vinasse and 52.8% by weight proteins with respect to the total weight dry matter of vinasse.

e) Molasses
SUGARCANE MOLASSES marketed by PRIMEAL. This molasses comprises 75% by weight dry matter with respect to the total weight of molasses and 5% by weight proteins with respect to the total weight dry matter of molasses.
BEET MOLASSES marketed by CRISTALUNION. This molasses comprises 75% by weight dry matter with respect to the total weight of molasses and 14% by weight proteins with respect to the total weight dry matter of molasses.

f) Probiotics
Yeasts LB 2245® marketed by LALLEMAND having the characteristics given in Table 1 below:

TABLE 1
Composition of Yeasts LB 2245

| | Yeasts LB 2245 (%) |
|---|---|
| Vitamin A (IU)< | 0.0003 |
| Water | 6 |
| Protids | 45.00 |
| Total lipids | 15.00 |
| SAT fatty acids | 10.00 |
| Total carbohydrates | 42.10 |
| Soluble sugars | 24.00 |
| Fibres | 16.60 |
| Sodium | 0.047 |
| Calcium | 0.212 |
| Iron | 0.005 |
| Vitamin B1: Thiamine | 0.004 |
| Vitamin B2: Riboflavin | 0.003 |
| Vitamin B3: Nicotinic acid | 0.048 |
| Vitamin B5: Pantothenic acid | 0.003 |
| Vitamin B6: Pyridoxine | 0.003 |
| Vitamin B8: Biotin | 0.0001 |
| Vitamin B9: Folic acid | 0.0002 |
| Vitamin B12: Cobalamin | 0.00001 |
| Remarks | Inactive yeasts, containing gluten from |
| | barley and wheat |

g) Vitamin Premixes
Vitamin premix PX SHRIMP V 0.5 marketed by MIXSCIENCE having the characteristics given in Table 2 below:

TABLE 2
Composition of the premix

| | Premix (%) |
|---|---|
| Iron | 0.20 |
| Iodine | 0.01 |
| Cobalt | 0.00238 |
| Copper | 0.60 |
| Manganese | 0.40 |
| Zinc | 0.3 |
| Selenium - Sodium selenite | 0.008 |
| BHT | 0.40 |
| Vitamin A (IU)< | 0.60 |
| Vitamin B1: Thiamine | 1.00 |
| Vitamin B2: Riboflavin | 1.20 |
| Vitamin B5: Pantothenic acid | 3.00 |
| Vitamin B6: Pyridoxine | 1.00 |
| Vitamin B8: Biotin | 0.01 |
| Vitamin B9: Folic acid | 0.16 |
| Vitamin B12: Cobalamin | 0.0001 |
| PP - Niacin | 3.00 |
| D3 | 0.0015 |
| E | 2.941176 |
| K3 | 0.20 |

B. Formulation of Gels According to the Invention

a) Gel Comprising a Probiotic and an Aqueous Substrate Constituted by Solubles from Maize

| | wt % with respect to |
|---|---|
| | the total weight of gel |
| Solubles from maize | 94.09 |
| Probiotics | 4.81 |
| Gelling agent (½ | 0.8 |
| Xanthan gum + ½ | |
| Carob gum) | |
| Potassium sorbate | 0.3 |

b) Gel Comprising a Vitamin Premix and an Aqueous Substrate Constituted by Solubles from Wheat

| | wt % with respect to |
|---|---|
| | the total weight of gel |
| Solubles from wheat | 94.09 |
| Vitamin premix | 4.81 |
| Gelling agent (½ | 0.8 |
| Xanthan gum + ½ | |
| Carob gum) | |
| Potassium sorbate | 0.3 |

c) Gel Comprising a Vitamin Premix and an Aqueous Substrate Constituted by Solubles from Maize

| | wt % with respect to |
|---|---|
| | the total weight of gel |
| Solubles from maize | 95.93 |
| Premix | 2.97 |
| Gelling agent (½ | 0.8 |
| Xanthan gum + ½ | |
| Carob gum) | |
| Sodium propionate | 0.3 |

d) Gel Comprising 75% of a Distillers' Soluble from Wheat and 25% of Water in the Aqueous Substrate

| | wt % with respect to |
|---|---|
| | the total weight of gel |
| Distillers' soluble | 74.17 |
| from wheat | |
| Water | 24.73 |
| Gelling agent (½ | 0.8 |
| Xanthan gum + ½ | |
| Carob gum) | |
| Potassium sorbate | 0.3 |

e) Gel Comprising an Aqueous Substrate Constituted by a Soluble from Wheat

| | wt % with respect to |
|---|---|
| | the total weight of gel |
| Soluble from wheat | 98.9 |
| Gelling agent (½ | 0.8 |
| Xanthan gum + ½ | |
| Carob gum) | |
| Potassium sorbate | 0.3 |

f) Gel Comprising an Aqueous Substrate Constituted by a Mixture of Soluble from Wheat and Soluble from Maize

| | wt % with respect to |
|---|---|
| | the total weight of gel |
| solubles from maize | 95.9 |
| solubles from wheat | 3.0 |
| Gelling agent (½ | 0.8 |
| Xanthan gum + ½ | |
| Carob gum) | |
| Potassium sorbate | 0.3 |

g) Gel Comprising an Aqueous Substrate Constituted by a Mixture of Soluble from Wheat at 75%, Gelled with Agar-Agar

| | wt % with respect to |
|---|---|
| | the total weight of gel |
| soluble from wheat | 75.0 |
| Water | 24.2 |
| Agar-agar | 0.5 |
| Potassium sorbate | 0.3 |

C. Preparation of a Gel

The above gels may be prepared as follows.

The coproduct(s) from agro-industry(ies) and optionally water is(are) heated in a stirred vat to a temperature greater than 80° C., then mixed with the other constituents of the mixture: the optional probiotics and premixes, with at least one gelling agent and with at least one preservative in the proportions given. The mixture thus obtained is then brought gradually back to ambient temperature so that the gel forms.

### EXAMPLE II: EFFECTS OF DIFFERENT GELS ACCORDING TO THE INVENTION ON THE DEVELOPMENT OF THE LARVAE OF TENEBRIO MOLITOR

Four coproducts from agro-industry were tested: two solubles from wheat (SB1 and SB2), a vinasse (VF) and a cereal soluble obtained from wheat, maize and barley (SC)

A gel was formed according to Example I, constituted by 99% by weight with respect to the total weight of gel, of an aqueous substrate comprising 25% by weight, with respect to the weight of aqueous substrate, of each of the aforementioned coproducts from agro-industry and 75% by weight, with respect to the weight of aqueous substrate of water, 0.7% of Flanogen XL12 (Cargill®), a 50/50 mixture of xanthan gum and carob gum, and 0.3% of potassium L-sorbate.

A control gel was also formed constituted by water, 0.7% by weight of Flanogen XL12 (Cargill®) and 0.3% by weight of potassium L-sorbate, the percentages by weight being with respect to the total weight of gel.

The larvae of Tenebrio molitor used for each series of experiments come from the same population originating from the laboratory rearing station of Ynsect at Evry, at two different times.

The experiments began with 10 grams of larvae after fasting for 48 h, with individual weight of about 20 mg.

They were reared at an optimum density of 0.63 g/cm² in transparent plastic jars with a square base (dimensions: 4×4×7.5 cm).

At each feed, the weight of insects is adjusted to 10 grams by random selection of a sample of individuals in order to return to the optimum density.

The experiments lasted 14 days and were carried out in the dark, in a climate chamber in order to control the temperature at 24° C. and the relative humidity at 60%. The larvae of Tenebrio molitor were fed ad libitum twice a week with a basic medium and the gels obtained as above.

At the end of the experiment the medium was weighed in order to evaluate the growth and mortality of the larvae reared in this way.

For calculating the daily growth rate it is necessary to determine the theoretical total growth, correcting for the effect of the successive dilutions. For this, the theoretical larval biomass (Mcumul) is evaluated again each time data are obtained (t), from the results of weighing larval mass (ML) according to the following formula:

$$Mcumul ( t ) = Mcumul ( t - 1 ) + Mcumul ( t - 1 ) \times \frac{ML ( t ) - ML ( t - 1 )}{ML ( t - 1 )}$$

The daily growth rate (GR) is calculated between the initial larval mass (ML(t0)=10 g) and the theoretical larval mass at the end of the experiment (tf) according to the following formula:

$$GR = \frac{Mcumul ( tf ) - ML ( t0 )}{ML ( t0 ) \times Δ t}$$

To estimate the mortality, the mean value of the daily apparent mortality rates between each data acquisition was calculated. The daily mortality rates were determined by dividing the number of deaths counted by the number of days between two feeds.

The results obtained are presented in FIG. 1a.

It is noted that adding a gel comprising the coproducts to the rearing medium of the larvae makes it possible to increase the growth of the larvae compared to a medium comprising a gel constituted only by water. Furthermore, the addition of such a gel, advantageously makes it possible to reduce the mortality of the larvae compared to the value of the control (gel constituted by water).

In FIG. 1b, it is noted that the biomass of the rearing medium increases throughout the 14 days of culture (from 10 g to 35 g). The biomass gain in the experiments conducted in the presence of gel comprising a coproduct is greater than the biomass gain in the control experiment, conducted in the presence of a gel comprising only water (difference of about 8 g).

Moreover, the feed conversion ratio FCR was calculated (by the method indicated in Table 3 below) for all of the experiments that were conducted. The results are presented in FIG. 1c. It can be seen that the feed conversion ratio in the experiments conducted in the presence of a coproduct is less than or equivalent to that obtained for the control.

In conclusion, the use of coproduct in gel form as the source of nutrients and water is particularly advantageous for growing larvae of Tenebrio molitor and gives improved growth compared to a gel constituted by water.

### EXAMPLE III: ADVANTAGES OF THE GELS ACCORDING TO THE INVENTION FOR THE DEVELOPMENT OF LARVAE OF TENEBRIO MOLITOR

Two series of experiments were undertaken based on nutrition regimes composed of coproducts from two starch mills, from wheat and maize for the first (factory A) and from wheat for the second (factory B).

The aims of each of these experiments were (1) to evaluate the effect of industrial drying on the nutritional quality of the coproducts and (2) to test the use of liquid coproducts in particular by incorporation in a gel that is simultaneously nutrient and a source of water, on performance in rearing Tenebrio molitor.

a) Biological Material and Rearing Conditions

The larvae of Tenebrio molitor used for each series of experiments were from the same colony originating from the laboratory rearing station of Ynsect at Evry and were taken at two different times.

The experiments began with 10 grams of larvae after fasting for 48 h, with individual weight of about 20 mg.

They were reared at an optimum density of 0.63 g/cm² in transparent plastic jars with a square base (dimensions: 4×4×7.5 cm).

At each feed, the weight of insects is adjusted to 10 grams by random selection of a sample of individuals in order to return to the optimum density.

The experiments lasted 2 weeks and were carried out in the dark in a climate chamber in order to control the temperature at 25° C. and the relative humidity at 60%. The larvae of Tenebrio molitor were fed ad libitum twice a week with 11 g of feed and a quantity of gel adjusted according to the moisture content of the substrate (see preceding paragraph). In total, the substrate was renewed 4 times, the renewal events corresponding to the different data acquisitions.

b) Experimental Procedure and Data Acquisition

The data were collected at each feed. The individuals were separated from the feed by manual sieving using a suitable sieve mesh as a function of the size of the individuals. The dead individuals were removed and counted. The live individuals were also counted. The live larvae and the residual matter (unconsumed feed, remaining gel and faeces) were weighed and a small portion (about 2 grams) was placed at 105° C. for 24 h and then weighed to determine the dry matter.

The variables studied are the daily growth rate (GR, calculated as stated in Example II) and the feed conversion ratio (FCR).

For calculating the FCR it is necessary to know the weight of feed consumed. However, the latter can only be obtained with difficulty by sieving, if at all, therefore it is necessary to perform a calculation and an intermediate experiment starting from a method by indirect calculation (confirmed in-house in the laboratory) so that the apparent digestibility and its derived indicator, the rejection rate (RR), are constant throughout the experiment, in other words so that the weight of faeces (or weight of frass) produced is proportional to the weight of feed ingested. An experiment in which 10 grams of larvae of Tenebrio molitor consumed their feed completely was therefore carried out for all the treatments in order to obtain the RR. The formulae for the calculations are given in the following table (Table 3).

TABLE 3
Formulae for calculating the feed conversion ratio (FCR)

| Variables | Unit | Formulae |
|---|---|---|
| FCR | — | $F C R = \frac{Weight of feed consumed}{Biomass gain}$ |
| RR | % | $R R = \frac{Weight of frass}{Weight of feed consumed}$ |
| Weight of feed consumed (Mc) | g | $Mc ( t ) = \frac{Substrate weight ( 0 ) - Substrate weight ( t )}{1 - R R}$ |

c) Evaluation of the Effect of Industrial Drying on the Nutritional Quality of the Coproducts

The treatments with a code ending with the letter S (A1S and A2S, B1S and B2S) correspond to nutrition regimes composed of a gel constituted only by water and a nutrient substrate, said substrate corresponding to liquid coproducts dried by two methods of drying: industrial drying and drying by lyophilization.

Preparation of the Feed and of the Gel

The nutrition regimes are formulated so as to respect the proportions of production of the coproducts given with respect to dry matter for each starch mill investigated.

The coproducts from starch manufacture included in the other nutrition regimes are:
wheat bran (WB_A and WB_B),
solubles from wheat originating from starch extraction (SB_A),
solubles from wheat originating from starch extraction, mixed with the solubles and the yeasts from distillation (SB_B),

WB_0 corresponds to a wheat bran from milling.

The ingredients used at 100% in treatments A1S (CPT_A) and B1S (CPT_B) correspond to products sold by the starch mills (dried industrially on site) and are composed by the liquid coproducts dried by lyophilization used in the respective nutrition regimes A2S (WB_A and SB_A) and B2S (WB_B and SB_B), and for which the proportions were maintained.

For each series, a “control” treatment composed of a nutrition regime based on wheat bran from milling and a gel comprising an aqueous substrate constituted by water was included (A0 and B0).

Each treatment was repeated 3 times.

Starch Mill A

TABLE 4
Design of experiments on the coproducts from starch mill A,
composition of the nutrition regimes

| | | | | | | Moisture |
|---|---|---|---|---|---|---|
| | | Substrate (%)** | | | | content of |
| Code | State | WB 0 | CPT A | WB A | SB A | substrate |
| A0 | DRY | 100% | 0.00 | 0.00 | 0.00 | 11% |
| A1S | DRY | 0.00 | 100% | 0.00 | 0.00 | 9% |
| A2S | DRY/LYO* | 0.00 | 0.00 | 65% | 35% | 8% |

*The feed was lyophilized
**The percentages are expressed with respect to dry matter

Starch Mill B

TABLE 5
Design of experiments on the coproducts from starch mill B,
composition of the nutrition regimes

| | | | | | | Moisture |
|---|---|---|---|---|---|---|
| | | Substrate (%)** | | | | content of |
| Code | State | WB 0 | CPT A | WB B | SB B | substrate |
| B0 | DRY | 100% | 0.00 | 0.00 | 0.00 | 11% |
| B1S | DRY | 0.00 | 100% | 0.00 | 0.00 | 10% |
| B2S | DRY/LYO* | 0.00 | 0.00 | 70% | 30% | 9% |

*The feed was lyophilized
**The percentages are expressed with respect to dry matter

All the dry nutrition regimes were prepared individually before the start of the study and stored in a dry, stable environment. For the treatments dried by lyophilization, the wet mixture of the coproducts is first placed at −80° C. for 24 hours, then kept in the lyophilizer for 3 days.

All the treatments received 11 grams of food per feed, independently of their dry matter content.

Regarding the gel given to the larvae of Tenebrio molitor as the source of water, it corresponds to small pieces composed of 0.75% of Flanogen XL12 (Cargill, France), which is a mixture of xanthan and carob gums, 0.3% of potassium sorbate, and made up with water. For the dry substrates, with a water content less than or equal to 15%, 6 grams of water were supplied by the gel.

Results

The nutrition regimes are presented in FIGS. 2a and 3a; the results are given in FIGS. 2b and 3b for the products from factory A and factory B, respectively.

As can be seen from these results, rearing carried out on dry substrates (A1S) and (B1S) does not make it possible to obtain such good yields in terms of growth and FCR as rearing carried out on lyophilized liquid substrates, (A2S/FIG. 2) and (B2S/FIG. 3) respectively.

As a result, it can be seen that industrial drying affects the nutritional quality of the coproducts used. It is therefore preferable to use the latter in their liquid form.

d) Use of Liquid Coproducts in Particular Incorporated in a Gel on Performance in Rearing Tenebrio molitor

The treatments make it possible to compare the different uses of the liquid coproducts: mixed in a wet substrate (A3 and B3) or incorporated in the gel (A4, A5 and B4).

Preparation of the Feed and of the Gel

The nutrition regimes are composed so as to respect the proportions of production of the coproducts given with respect to dry matter for each starch industry investigated.

The coproducts from starch manufacture included in the nutrition regimes are:
wheat bran (WB_A and WB_B),
solubles from wheat originating from starch extraction (SB_A),
solubles from wheat originating from starch extraction and mixed with the solubles and with the distillation yeasts (SB_B),
solubles from maize originating from the steeping process (SM_A),
maize germ cake (GM_A), and
wet maize fibres (FM_A).

TABLE 6
Design of experiments on the coproducts from starch mill A,
composition of the nutrition regimes

| | | | | | | | | | Moisture |
|---|---|---|---|---|---|---|---|---|---|
| | Gel | Substrate (%)** | | | | | Gel (%)** | | content of |
| Code | enriched | WBA | SBA | SM A | GM A | FM A | SB A | SM A | substrate |
| A3 | No | 39.0% | 21.0% | 12.0% | 5.9% | 22.1% | 0.00 | 0.00 | 52% |
| A4 | Yes | 39.0% | 0.00 | 12.0% | 5.9% | 22.1% | 21.0% | 0.00 | 42% |
| A5 | Yes | 39.0% | 4.9% | 12.0% | 5.9% | 22.1% | 16.1% | 9.2% | 44% |

**The percentages are expressed with respect to dry matter

TABLE 7
Design of experiments on the coproducts from starch
mill B, composition of the nutrition regimes

| | | | | Gel | Moisture |
|---|---|---|---|---|---|
| | Gel | Substrate (%)** | | (%)** | content of |
| Code | enriched | WB B | SB B | SB B | substrate |
| B3 | No | 70.0% | 30.0% | 0.00 | 56% |
| B4 | Yes | 70.0% | 30.0% | 19.5% | 49% |

**The percentages are expressed with respect to dry matter

TABLE 8
Composition of the gels (starch mill A)

| | | | | | Weight | Water |
|---|---|---|---|---|---|---|
| | Gel | Gel (%) | | | of gel | content |
| Code | enriched | SB A | SM A | WATER | (g) | of the gel |
| A3 | No | 0% | 0% | 100% | 3.5 g | 100% |
| A4 | Yes | 100% | 0% | 0% | 5.8 g | 70.7% |
| A5 | Yes | 74.5% | 25.5% | 0% | 6.1 g | 66.1% |

TABLE 9
Composition of the gels (starch mill B)

| | | | | | Water |
|---|---|---|---|---|---|
| | | Gel | | Weight | content |
| | Gel | (%) | | of gel | of the |
| Code | enriched | SB B | WATER | (g) | gel |
| B3 | No | 0.00 | 100% | 3.2 g | 100% |
| B4 | Yes | 75.0% | 25.0% | 4.4 g | 85.1% |

All the dry nutrition regimes were prepared individually before the start of the study and were stored in a dry, stable environment.

All the wet nutrition regimes were prepared on the day of feeding to keep the moisture content of the substrate stable and avoid microbiological contamination. Powdered potassium sorbate was also added (0.3%) to the substrate and mixed well. All the treatments received 11 grams of food per feed, independently of their dry matter content.

Regarding the gel given to the larvae of Tenebrio molitor, it corresponds to small pieces composed of 0.75% of Flanogen XL12 (Cargill, France), which is a mixture of xanthan and carob gums, 0.3% of potassium sorbate and made up with water and/or a liquid coproduct, depending on the treatment. The quantity of gel provided in the diet was adjusted as a function of the moisture content of the substrate to avoid overfeeding the larvae of Tenebrio molitor with water. For the dry substrates with a water content less than or equal to 15%, 6 grams of water was supplied by the gel.

For the substrates with a water content greater than 15%, the quantity of water to be supplied by the gel was calculated according to the following formula:

[Weight of water in the gel in grams]=−([Moisture content of the substrate as percentage]/15%)+7

As before, the nutrition regimes are composed so as to respect the proportions of production of the coproducts given with respect to dry matter for each starch mill investigated.

For each series, a “control” treatment composed of a nutrition regime based on wheat bran from milling and gel was included (A0 and B0). WB_0 corresponds to wheat bran from milling.

Each treatment was repeated 3 times.

Results

The nutrition regimes are presented in FIGS. 4a and 5a; the results are given in FIGS. 4b and 5b for the products originating from factory A and factory B.

Comparison of rearing conducted on a wet substrate comprising a coproduct (A3) and (B3), and on a substrate comprising the coproduct(s) in the form of gel (A4, A5) and (B4), clearly shows that the growth rate is better when the coproduct is supplied in the form of gel, as well as the FCR (the rate having to be as low as possible).

This may be explained by the fact that a wet medium increases the mortality of individuals. Thus, supplying the coproduct in the form of gel makes it possible to supply a coproduct in a liquid form the nutritional qualities of which are preserved, without causing an increased risk of mortality, which would be due to an excessive water content of the medium.

### EXAMPLE IV

Evaluation of the Effect of the Percentage of Gelling Agent on the Physical Properties of the Enriched Gels and the Consequences on the Consumption of the Larvae;

Investigation of Different Gelling Agents on the Strength of the Enriched Gels for Three Levels of Incorporation;

Consequences on the Consumption of the Larvae.

a) Preparation of the Gels

The gels used in this study are presented in Table 10 below. The liquid coproduct (solubles from wheat originating from starch extraction, mixed with the solubles and with the distillation yeasts) is incorporated between 99% and 99.4% in the enriched gels, counting addition of potassium sorbate at 0.3% and according to inclusion of the gelling agent at 0.30%, 0.50% and 0.70% (by weight with respect to the total weight of the gel). The gelling agents used are: a mixture of xanthan and carob gums (Flanogen XL12, Cargill France), a mixture of xanthan and guar gums (Algaia, France) and agar-agar intended for the agri-food industry (Biocean, France). The enriched gels were produced at 80° C. for 15 minutes using an “Amicook” multifunction food processor (Amicook Family gourmet, France). They were poured quickly into cylindrical dishes with a volume of 137.4 cm³, and then placed at 4° C. for 24 hours for setting. All the gels have a standard volume of 78.5 cm³ (height: 4 cm; diameter: 5 cm).

TABLE 10
Preparation of the enriched gels

Liquid coproduct
Solubles from wheat

| Gelling agent | Xanthan Carob | Xanthan Guar | Agar |
|---|---|---|---|
| % incorporation | 0.30% | 0.30% | 0.30% |
| of gelling | 0.50% | 0.50% | 0.50% |
| agent | 0.70% | 0.70% | 0.70% |

b) Analysis of Gel Texture

The mechanical properties of the gels were evaluated using a TA-XT Plus texturometer (Stable Micro Systems, TA.XT Plus, Surrey, France) and its “Exponent” analysis software. This method makes it possible to measure the hardness, elasticity and mainly the strength of the different gels tested. A cylindrical spindle with a diameter of 6.45 mm was used for applying pressure to the surface of the gel until the maximum depression of 20 mm after contact was reached. The speed of penetration was fixed at 1.6 mm/s and the speed of withdrawal at 10 mm/s. The test was carried out with the gels enriched with solubles from wheat with a concentration of gelling agent (Xanthan Carob mixture) of 0.30%, 0.50% and 0.70%. In FIG. 6, the bottom curve relates to incorporation of 0.30% of gelling agent, the middle curve relates to incorporation of 0.50% of gelling agent and the top curve relates to incorporation of 0.70% of gelling agent.

The following texture parameters were determined from the graph in FIG. 6 representing the strength as a function of the distance traveled by the probe:
the gel strength (g/cm²) corresponding to the force required for breaking and piercing the gel,
the deformation (mm) corresponding to the distance traveled by the probe between initial contact and rupture of the gel, and
the firmness, corresponding to the ratio of the gel strength to its deformation.

c) Study of the Rate of Consumption of the Gels by the Larvae of Tenebrio molitor

The larvae of Tenebrio molitor used for this experiment were from the same colony originating from the laboratory rearing station of Ynsect at Evry and were taken from the same batch at the same time. They were fasted for 48 h before the start and had a mean initial weight of 33 mg. A ratio of 0.5 g of gel to 2.5 g of larvae was placed in transparent plastic jars with a square base (dimensions: 4×4×7.5 cm). The enriched gels were cut out using a punch and placed at the centre of the jar to guarantee the same area of access to the gel by the larvae.

The experiment was carried out in the dark in a climate chamber in order to control the temperature at 26° C. and the relative humidity at 60%. Observations were carried out hourly until complete consumption of the gel. Once the gel had been consumed completely, the mortality and the individual weight of the larvae were found by counting and weighing.

d) Results

d1) Effect of the Concentration of Gelling Agent on the Strength of the Enriched Gel and on the Consumption of the Larvae

The results presented in Table 11 below show that the strength and the firmness of the gel increase with the concentration of gelling agent, ranging from a strength of 56.92 g/cm² for 0.3% to 149.09 g/cm² for 0.7%, i.e. a tripling of the strength for an increase of 0.4% in the concentration of gelling agent. The capacity for deformation of the gels increases slightly with the concentration of gelling agent.

TABLE 11
Results for strength, deformation, firmness and
consumption of the gels enriched with solubles
from wheat (gelling agent: Xanthan Carob).

| % | | | | | |
|---|---|---|---|---|---|
| incor- | | | | | |
| poration | | | | Consumption | Weight |
| of gelling | Strength | Deformation | Firmness | time | gain |
| agent | (g/cm²) | (mm) | (slope) | (h) | (%) |
| 0.30% | 56.92 | 5.92 | 14.27 | 9.7 (+/−0.7) | 9.8% |
| 0.50% | 117.15 | 6.17 | 29.28 | 10.3 (+/−0.3) | 10.1% |
| 0.70% | 149.02 | 6.27 | 36.98 | 14.7 (+/−1.2) | 9.0% |

The results show that the consumption time of the gels increases slightly with the concentration of gelling agent: 5 hours of additional consumption time for a gel at 0.7% of gelling agent relative to a gel at 0.3%. The mortality and the weight gain of the larvae are equivalent regardless of the concentration of gelling agent. Thus, the results show that a gel enriched with liquid coproducts is more easily consumed by the larvae of T. molitor when the gel strength is about 50 g/cm². Other observations (not presented) show that, for a gel strength less than 20 g/cm², the gel does not form, the solution of liquid coproduct flows in the rearing unit, and consequently the larvae become stuck and die.

d2) Effect of the Gelling Agent on the Consumption of the Gels by the Larvae

The results given in Table 12 below show that for enriched gels of an equivalent strength (about 50 g/cm²), the time for complete consumption of the gel is comparable: between 10 and 11 hours. The gelling agent therefore does not have a significant effect on the appetence of the gels. Thus, various gelling agents may be used for the purposes of the invention to achieve similar results for the consumption of the gel by the larvae.

TABLE 12
Effect of the gelling agent on the consumption of enriched gels

| | Strength | Consumption time | Weight gain |
|---|---|---|---|
| Gelling agent | (g/cm²) | (h) | (%) |
| Xanthan Carob | 56.92 | 9.7 (+/−0.7) | 9.8% |
| Xanthan Guar | 42.09 | 10.3 (+/−1.3) | 10.2% |
| Agar-Agar | 47.24 | 11.3 (+/−0.3) | 10.2% |

1. Gel comprising:
90 to 99.6% by weight of an aqueous substrate comprising at least 25% by weight with respect to the total weight of aqueous substrate, of a liquid coproduct from agro-industry,
from 0.3 to 2% by weight of a gelling agent, and
from 0.1 to 5% by weight of a preservative,
the percentages by weight of aqueous substrate, gelling agent and preservative being expressed with respect to the total weight of the gel,
said gel having a water content greater than 50% by weight with respect to the total weight of gel.

2. Gel according to claim 1, in which the agro-industry is selected from the industries of starch manufacture, potato starch manufacture, malting, bioethanol production, sugar, fermentation, brewing, distillation and the dairy industry.

3. Gel according to claim 1, in which the aqueous substrate comprises at least 50% by weight of a liquid coproduct from agro-industry with respect to the total weight of aqueous substrate.

4. Gel according to claim 1, in which the aqueous substrate comprises water.

5. Gel according to claim 4, in which the aqueous substrate consists of water and a liquid coproduct from agro-industry.

6. Gel according to claim 1, in which the aqueous substrate consists of a liquid coproduct from agro-industry.

7. Gel according to claim 1, in which the liquid coproduct from agro-industry is selected from the list constituted by solubles from cereals, solubles from maize, solubles from wheat, solubles from peas, solubles from cassava, solubles from sugar beet, solubles from sugar cane, distillers' solubles from cereals, distillers' solubles from wheat, distillers' solubles from maize, distillers' solubles from peas, distillers' solubles from cassava, vinasses, molasses, yeast creams, whey and concentrated derivatives thereof, in particular permeate, or mixtures thereof.

8. Gel according to claim 1, in which the liquid coproduct from agro-industry is a distillers' soluble or a mixture of a distillers' soluble and another liquid coproduct.

9. Gel according to claim 1, in which the gelling agent is a mixture of xanthan and carob gums, or a mixture of xanthan and guar gums.

10. Gel according to claim 1, comprising yeasts.

11. Gel according to claim 1, further comprising from 0.001 to 0.5% by weight of vitamins with respect to the total weight of the gel.

12. Gel according to claim 1, having a gel strength of at least 30 g/cm².

13. Nutrition regime for insects comprising a gel and a feed:
the gel being according to claim 1, and
the feed being an insoluble substrate having a moisture content less than or equal to 55% by weight with respect to the total weight of the insoluble substrate.

14. Method for preparing a gel according to claim 1, comprising:
a step of forming a liquid compound by mixing:
i. from 90 to 99.6% by weight of an aqueous substrate comprising at least 25% by weight with respect to the total weight of aqueous substrate, of a liquid coproduct from agro-industry, the aqueous substrate being brought to a temperature allowing dissolution of a gelling agent;
ii. from 0.3 to 2% by weight of a gelling agent, and
iii. from 0.1 to 5% by weight of a preservative,
the percentages by weight of gelling agent and of preservative being expressed with respect to the total weight of the liquid compound,
a step of cooling the liquid compound so as to bring it below a second temperature, at which it gels.

15. Use of a gel according to claim 1, as a source of water and/or nutrients for rearing insects.

16. Use of a liquid coproduct from agro-industry in gel form as a source of water and/or nutrients for rearing insects.
